(19) United States
(12) Patent Application Publication
(10) Pub. No.: US 2022/0005636 A1
(43) Pub. Date: Jan. 6, 2022

(54) SOFT MAGNETIC POWDER, METHOD FOR PERFORMING HEAT TREATMENT OF SOFT MAGNETIC POWDER, SOFT MAGNETIC MATERIAL, DUST CORE, AND METHOD FOR PRODUCTION OF DUST CORE

(71) Applicant: DOWA ELECTRONICS MATERIALS CO., LTD., Tokyo (JP)

(72) Inventors: Takeshi KAWAUCHI, Tokyo (JP); Kyoso MASUDA, Tokyo (JP); Kenichi INOUE, Tokyo (JP)

(73) Assignee: DOWA ELECTRONICS MATERIALS CO., LTD., Tokyo (JP)

(21) Appl. No.: 17/289,028

(22) PCT Filed: Oct. 30, 2019
(86) PCT No.: PCT/JP2019/042467

§ 371 Date: Apr. 27, 2021

(51) Int. Cl. H01F 1/147; H01F 41/02; H01F 27/255; B22F 1/00

(52) U.S. Cl. CPC H01F 1/14741; H01F 41/0246; H01F 27/255; B22F 2304/10; B22F 2201/03; B22F 2301/35; B22F 1/0044

(57) ABSTRACT

A soft magnetic powder, including an Fe alloy, and containing 0.1 to 15 mass % of Si, wherein a ratio (Si/Fe) of an atomic concentration of Si and an atomic concentration of Fe is from 4.5 to 30 at a depth of 1 nm from a particle surface of the soft magnetic powder.

### FIELD OF THE INVENTION

The present invention relates to a soft magnetic powder, a method for performing a heat treatment to a soft magnetic powder, a soft magnetic material, a dust core, and a method for production of a dust core.

### BACKGROUND OF THE INVENTION

An electronic device is equipped with a magnetic component such as an inductor, which has a dust core. Electronic devices have been required to be adapted to higher frequencies in order to attain improved performance and miniaturization, and accordingly, a dust core that constitutes a magnetic component is also required to be adapted to such higher frequencies.

In general, the dust core is produced by compression molding, after a soft magnetic powder is composited with a binding material such as a resin, if necessary. When an alternating magnetic flux is passed through the resulting dust core, some of energy is lost and heat is generated, which causes a problem in electronic devices. Such magnetic loss includes hysteresis loss and eddy current loss. In order to reduce the hysteresis loss, it is required to reduce the coercive force Hc of the dust core and to increase the magnetic permeability μ. In addition, there have been studies on measures to reduce the eddy current loss, such as forming an insulation film on a particle surface of a soft magnetic powder constituting a dust core to improve electrical insulation, reducing a particle size of a soft magnetic powder, and the like (magnetic loss and magnetic properties of a dust core formed from a soft magnetic material including a soft magnetic powder may be hereinafter referred to, for example, as “magnetic loss of the soft magnetic powder”, and “magnetic properties of the soft magnetic powder”, respectively). Since the eddy current loss is proportional to the square of a frequency, the eddy current loss increases as the frequency of the alternating current used increases. Therefore, it is particularly important to reduce the eddy current loss.

In the dust core used for power supply applications, high saturation magnetization is required to improve the direct current superimposition characteristics. However, taking measures to reduce the eddy current loss as described above increases non-magnetic components, which increases the potential of decreasing saturation magnetization. The problem is to achieve both high saturation magnetization and reduced eddy current loss.

Since a high magnetic permeability can be obtained, an FeSi alloy powder which contains Si has been proposed as the soft magnetic powder (see, for example, Patent Document 1). Patent Document 1 describes that the soft magnetic properties can be improved by compounding 5 to 7 mass % of Si.

Further, Patent Documents 2 to 5 describe that FeSi powder, FeSiCr powder, and FeSiCr powder surface-treated with tetraalkoxysilane are subjected to heat treatment at a temperature from about 400 to 1,100° C. in a reducing atmosphere such as a hydrogen atmosphere or in an inert atmosphere such as a nitrogen atmosphere. High-temperature heat treatment in such a non-oxidizing atmosphere (i.e., a substantially oxygen-free atmosphere) is generally performed to eliminate residual stress and distortion in the powder while preventing oxidation of the powder. Oxidation of the powder may lead to deteriorated magnetic properties such as saturation magnetization. For example, eliminating distortion in the powder can facilitate magnetic domain wall displacement and reduce coercive force of the soft magnetic powder.

### PRIOR ART DOCUMENT

### [Patent Document]

[Patent document 1] Japanese Unexamined Patent Publication No. 2016-171167
[Patent document 2] Japanese Patent No. 4024705
[Patent document 3] Japanese Unexamined Patent Publication No. 2010-272604
[Patent document 4] Japanese Patent No. 5099480
[Patent document 5] Japanese Unexamined Patent Publication No. 2009-88502

### SUMMARY OF THE INVENTION

### Problems to be Solved by the Invention

As described in Patent Document 1, the soft magnetic powder containing Fe and Si is excellent in magnetic properties. As mentioned above, in the soft magnetic powder, high saturation magnetization and reduced eddy current loss are desired. Especially in the soft magnetic powder used in the high frequency region, reduced eddy current loss is strongly desired. The present inventors have examined and found that the soft magnetic powder obtained by performing the heat treatment in a given atmosphere, as disclosed in Patent Documents 2 to 5, has sufficient saturation magnetization but insufficient electrical insulation, and that there is a concern in terms of reduction of the eddy current loss.

Therefore, it is a problem of the present invention to achieve excellent electrical insulation in the soft magnetic powder containing Fe and Si, while maintaining the saturation magnetization at the level equal to that in the conventional technology, and to provide a method for production of the soft magnetic powder.

### Means for Solving the Problem

The present inventors have studied intensively to solve the above problems. As a result, the present inventors have found that the heat treatment of the soft magnetic powder containing Fe and Si at a predetermined temperature in an atmosphere containing a trace amount of oxygen can provide a soft magnetic powder having saturation magnetization at the level equal to or higher than that in the conventional technology and sufficiently high electrical insulation, and have completed the present invention.

Namely, the present invention is as follows.

A soft magnetic powder, including an Fe alloy, and containing 0.1 to 15 mass % of Si, wherein a ratio (Si/Fe) of an atomic concentration of Si and an atomic concentration of Fe is from 4.5 to 30 at a depth of 1 nm from a particle surface of the soft magnetic powder.

A volume-based cumulative 50% particle size (D50) of the soft magnetic powder measured with a laser diffraction particle size distribution analyzer is preferably from 0.1 to 15 μm, and more preferably from 0.5 to 8 μm.

The soft magnetic powder preferably contains from 84 to 99.7 mass % of Fe, and preferably contains from 0.2 to 10 mass % of Si. More preferably, the soft magnetic powder further contains Cr, and a content of the Cr is preferably from 0.1 to 8 mass %.

A method for performing a heat treatment to a soft magnetic powder of the present invention includes a heat treatment step of performing a heat treatment to a soft magnetic powder including an Fe alloy containing from 0.1 to 15 mass % of Si at 450 to 1,100° C. in an atmosphere at oxygen concentration of 1 to 2,500 ppm.

In the heat treatment step, the heat treatment is preferably performed for 10 to 1,800 minutes. Preferably, the soft magnetic powder subjected to the heat treatment step further contains Cr, and a content of the Cr is from 0.1 to 8 mass %.

A soft magnetic material of the present invention includes, e.g., the soft magnetic powder and a binder. A dust core of the present invention includes the soft magnetic powder. The dust core can be produced by molding the soft magnetic powder or the soft magnetic material into a predetermined shape; and heating the obtained molding.

### Advantageous Effect of the Invention

According to the present invention, there is provided a soft magnetic powder containing Fe and Si, which has an excellent electrical insulation, while maintaining the saturation magnetization at the level equal to that in the conventional technology.

### BRIEF DESCRIPTION OF DRAWINGS

FIG. 1 is a diagram illustrating ESCA measurement results (ratio of atomic concentrations of Si and Fe) of Example 1 and Comparative Example 1. FIG. 1(a) illustrates the measurement result up to a depth of 30 nm, and FIG. 1(b) illustrates the measurement result up to a depth of 300 nm.

### DETAILED DESCRIPTION OF THE INVENTION

Hereinafter, the embodiment of a soft magnetic powder of the present invention and a method for production thereof (a method for performing a heat treatment to the soft magnetic powder) will be described.

### <Soft Magnetic Powder>

The embodiment of the soft magnetic powder of the present invention includes an Fe (iron) alloy containing Si (silicon).

### (Alloy Composition)

The soft magnetic powder contains Si in a range from 0.1 to 15 mass %, and preferably contains Fe as a main component. Fe is an element that contributes to the magnetic properties and the mechanical properties of the soft magnetic powder. Si is an element that enhances the magnetic properties such as the magnetic permeability of the soft magnetic powder. The term “main component” described above regarding Fe means that the element has the highest content among the elements included in the soft magnetic powder. The content of Fe in the soft magnetic powder is preferably from 84 to 99.7 mass %, and more preferably from 88 to 98.2 mass %, from the viewpoint of the magnetic properties and the mechanical properties. The content of Si in the soft magnetic powder is to be in the above range from the viewpoint of enhancing the magnetic properties such as the magnetic permeability without impairing the magnetic properties and the mechanical properties attributable to Fe. In the present invention, as described below, Si is localized in the vicinity of the particle surface of the soft magnetic powder, so that the soft magnetic powder has excellent electrical insulation. From the viewpoint of the electrical insulation and magnetic properties, the content of Si is preferably from 0.2 to 10 mass %, and more preferably from 1.2 to 8 mass %. Further, the total content of Fe and Si in the soft magnetic powder is preferably 90 mass % or more from the viewpoint of suppressing the deterioration of the magnetic properties due to the inclusion of impurities.

The embodiment of the soft magnetic powder of the present invention preferably contains Cr (chromium) from the viewpoint of lowering the content of oxygen in the powder to enhance the magnetic properties such as saturation magnetization, and increasing the oxidation resistance of the powder. In this soft magnetic powder, the content of Cr is preferably from 0.1 to 8 mass %, and more preferably from 0.5 to 7 mass %, from the viewpoint described above. Further, the total content of Fe, Si, and Cr in the soft magnetic powder is preferably 97 mass % or more from the viewpoint of suppressing the deterioration of the magnetic properties due to the inclusion of impurities.

In addition to Fe, Si and Cr described above, the soft magnetic powder of this embodiment may contain other elements in such a range that the effects of the present invention are exhibited. Examples of such elements include Na (sodium), K (potassium), Ca (calcium), Pd (palladium), Mg (magnesium), Co (cobalt), Mo (molybdenum), Zr (zirconium), C (carbon), N (nitrogen), O (oxygen), P (phosphorus), Cl (chlorine), Mn (manganese), Ni (nickel), Cu (copper), S (sulfur), As (arsenic), B (boron), Sn (tin), Ti (titanium), V (vanadium), and Al (aluminum). The content of the above described elements excluding oxygen is preferably 1 mass % or less in total, and more preferably from 10 to 5,000 ppm.

In the embodiment of the soft magnetic powder of the present invention, the content of oxygen contained as an unavoidable impurity is preferably low from the viewpoint of obtaining good saturation magnetization. The content of oxygen increases as the particle size of the powder decreases. Therefore, the present invention adopts a product (O×D50 (mass %·μm)) of the content of oxygen (O) and the volume-based cumulative 50% particle size (D50) of the soft magnetic powder measured with a laser diffraction particle size distribution analyzer for the purpose of correcting variation in the content of oxygen attributable to the particle size. The product (O×D50 (mass %·μm)) is preferably 8 (mass %·μm) or less, and more preferably from 0.40 to 7.50 (mass %·μm), from the viewpoint of obtaining a good saturation magnetization of the soft magnetic powder.

### (Atomic Concentration Ratio Si/Fe in Vicinity of Particle Surface)

An embodiment of the soft magnetic powder of the present invention has Si localized in the vicinity of the particle surface, which is considered to function like an insulation film (and does not adversely affect the saturation magnetization) to achieve an excellent electrical insulation of the soft magnetic powder. As for the localization of Si, specifically, the ratio (Si/Fe) of the atomic concentration (at %) of Si to the atomic concentration (at %) of Fe at a depth of 1 nm from the particle surface of the soft magnetic powder is from 4.5 to 30. In the present specification, the atomic concentration of each element at a depth of 1 nm from the particle surface of the soft magnetic powder is measured as follows (details are described later in Examples).

Measuring apparatus: PHI 5800, ESCA SYSTEM manufactured by ULVAC-PHI INC.

Measured photoelectron spectra: Fe2p, Si2p

Analyzed diameter: ϕ 0.8 mm

Emission angle of the measured photoelectrons with respect to the sample surface: 45°

X-ray source: Monochromatic Al radiation source

X-ray source output: 150 W

Background Processing: Shirley Process

The Ar sputter etching rate is set at 1 nm/min in terms of SiO₂, and measurement is performed at 81 points for the sputtering time from 0 to 300 min, beginning from the outermost surface. The ratio (Si/Fe) of the atomic concentrations of Si and Fe is calculated using the atomic concentration value of Si and the atomic concentration value of Fe at the sputtering time of 1 min, where the sputtering time of 1 min is assumed to correspond to a depth of 1 nm from the particle surface.

With the ratio (Si/Fe) of atomic concentrations of Si and Fe at a depth of 1 nm from the particle surface of the soft magnetic powder being less than 4.5, it is difficult to achieve an excellent electrical insulation. In contrast, with the ratio (Si/Fe) exceeding 30, it is difficult to produce. From the viewpoint of achieving excellent electrical insulation and of actual production, the ratio (Si/Fe) of atomic concentration is preferably from 6 to 28, more preferably from 7.6 to 26, and even more preferably from 11.5 to 26.

Further, the ratio (Si/Fe) of atomic concentrations of Si and Fe at a depth of 300 nm from the particle surface of the embodiment of the soft magnetic powder of the present invention is preferably from 0.001 to 0.5 from the viewpoint of obtaining a uniform alloy in which segregation inside the particles is prevented to achieve good magnetic properties. In the present specification, the atomic concentration of each element at a depth of 300 nm from the surface of the particle of the soft magnetic powder is measured similar to the method for measuring the atomic concentration of the element at the depth of 1 nm. The atomic concentration value of Si and the atomic concentration value of Fe at the sputtering time of 300 min are used to obtain the ratio (Si/Fe) of the atomic concentrations of Si and Fe, where the sputtering time of 300 min is assumed to correspond to the depth of 300 nm.

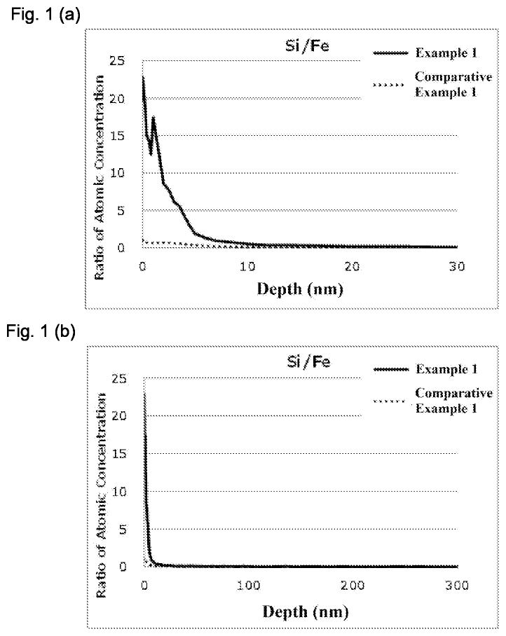

Here, the distribution of Si in the soft magnetic powder will be described. As described above, in the embodiment of the soft magnetic powder of the present invention, Si is localized on the surface side of the particles. For example, as illustrated in FIG. 1 (solid line) described later, the ratio (Si/Fe) of the atomic concentration is small and uniform in the inside of the particle, but is obviously larger in a certain range in the vicinity of the particle surface compared to the inside of the particle. In other words, the proportion of Si is higher on the surface side than in the inside.

Specifically, in the region from the particle surface to a depth of 2 nm, the ratio (Si/Fe) of the atomic concentration is preferably from 4.5 to 30, and in the region from the depth of more than 2 nm to the depth of 4 nm or less from the particle surface, the ratio (Si/Fe) of the atomic concentration is preferably from 1 to 30. Further, in the inside deep from the surface region (the region at a depth of 100 nm or more from the particle surface), the ratio (Si/Fe) of the atomic concentration is preferably from 0.001 to 0.5.

### (Average Particle Size (D50))

A volume-based cumulative 50% particle size (D50) of the embodiment of the soft magnetic powder of the present invention measured with a laser diffraction particle size distribution analyzer is not particularly limited, and preferably from 0.1 to 15 μm, and more preferably from 0.5 to 8 μm, from the viewpoint of reducing an eddy current loss by making the particles finer.

### (BET Specific Surface Area)

The specific surface area measured by the BET one-point method (BET specific surface area) of the embodiment of the soft magnetic powder of the present invention is preferably from 0.15 to 3.00 m²/g, more preferably from 0.20 to 2.50 m²/g, from the viewpoint of suppressing the generation of oxides on the particle surface of the powder and developing good magnetic properties.

### (Tap Density)

A tap density of the embodiment of the soft magnetic powder of the present invention is preferably from 2.0 to 7.5 g/cm³, more preferably from 2.8 to 6.5 g/cm³, from the viewpoint of increasing the packing density of the powder to exert good magnetic properties.

### (Properties in X-Ray Diffraction (XRD) Measurement)

In the case of XRD measurement of the embodiment of the soft magnetic powder of the present invention, a strong peak is likely observed at the plane index (1, 1, 0), and the peak is useful for analyzing the crystal structure of the powder.

The peak position is usually in the range of 2θ=52.40 to 52.55°.

The d value determined from the peak is usually from 2.015 to 2.030 Å.

The full width at half maximum (FWHM) of the peak is usually from 0.060 to 0.110° (the corresponding crystallite size is from 937 to 1,563 Å), and preferably from 0.065 to 0.105° (the corresponding crystallite size is from 984 to 1,485 Å). With such a small full width at half maximum of a diffraction peak in XRD (i.e., with a large crystallite size), the soft magnetic powder tends to be excellent in the magnetic properties.

The integral width of the above described peak is usually from 0.100 to 0.160°.

### (Shape)

The shape of the embodiment of the soft magnetic powder of the present invention is not particularly limited, and may be spherical or approximately spherical, or may be granular, laminar (flake-like), or distorted (irregular).

### (Electrical Insulation)

The embodiment of the soft magnetic powder of the present invention is excellent in the electrical insulation because Si is localized on the particle surface as described above. Specifically, the resistance R (volume resistivity) of the pressed product of the soft magnetic powder obtained in the following pressed powder resistance test is preferably from 3.0×10³ to 5.0×10⁶ Ω·cm, and more preferably from 3.5×10³ to 1.0×10⁶ Ω·cm.

### [Pressed Powder Resistance Test]

After packing 6.0 g of the soft magnetic powder into a measurement container of a powder resistance measurement system (MCP-PD51 type manufactured by Mitsubishi Chemical Analytech Co., Ltd.), pressurization is started and the volume resistivity of a circular-shaped pressed powder with a cross-section of ϕ 20 mm is measured at the time when an applied load reaches 20 kN.

### (Balance Between Electrical Insulation and Saturation Magnetization)

As explained in the section [Background of the invention], compatibility between good saturation magnetization and low eddy current loss is required for the soft magnetic powder, but taking a step to reduce the eddy current loss may result in a reduction of the saturation magnetization in some cases. The embodiment of the soft magnetic powder of the present invention has attained the above-described compatibility, and thus has excellent electrical insulation and ensures a predetermined value of the saturation magnetization. Specifically, a product (log R×σs) of the common logarithm (log R) of the numerical value of the pressed powder resistance R (Ω·cm) and the saturation magnetization as (emu/g) of the soft magnetic powder is preferably 600 (emu/g) or more, more preferably from 620 to 1,400 (emu/g).

### <Method for Performing Heat Treatment to Soft Magnetic Powder>

The embodiment of the soft magnetic powder of the present invention described above can be obtained by an embodiment of a method for performing a heat treatment to a soft magnetic powder of the present invention. The method for performing a heat treatment includes a heat treatment step of performing a heat treatment to a predetermined soft magnetic powder at 450 to 1,100° C. in an atmosphere at oxygen concentration of 1 to 2,500 ppm. The method for performing a heat treatment will be hereinafter described.

### (Raw Material Powder)

In the embodiment of the method for performing a heat treatment to the soft magnetic powder of the present invention, a soft magnetic powder (hereinafter also referred to as a “raw material powder”) subjected to the heat treatment step is substantially the same in composition, shape, etc., but different in Si localization state, relative to the embodiment of the soft magnetic powder of the present invention.

That is, the raw material powder includes an Fe alloy containing Si in a range from 0.1 to 15 mass %, and preferably contains Fe as a main component (a component with the highest content among the elements constituting the powder). The content of Fe in the raw material powder is preferably from 84 to 99.7 mass %, more preferably from 88 to 98.2 mass %. The content of Si is preferably from 0.2 to 10 mass %, more preferably from 1.2 to 8 mass %. Further, the total content of Fe and Si in the soft magnetic powder is preferably 90 mass % or more. The raw material powder preferably contains Cr (chromium), and its content is preferably from 0.1 to 8 mass %, more preferably from 0.5 to 7 mass %. In this case, the total content of Fe, Si and Cr in the raw material powder is preferably 97 mass % or more. The raw material powder may contain other elements in such a range that the effects of the present invention are exhibited, and examples thereof include Na, K, Ca, Pd, Mg, Co, Mo, Zr, C, N, O, P, Cl, Mn, Ni, Cu, S, As, B, Sn, Ti, V and Al. The content of the above described elements excluding oxygen is preferably 1 mass % or less in total, more preferably from 10 to 5,000 ppm.

The ratio (Si/Fe) of the atomic concentration (at %) of Si and the atomic concentration (at %) of Fe at a depth of 1 nm from the particle surface of the raw material powder is usually from 0.05 to 2.5. Further, the ratio (Si/Fe) of the atomic concentrations of Si and Fe at a depth of 300 nm from the particle surface of the raw material powder is preferably from 0.001 to 0.5.

A product (O×D50 (mass %·μm)) of the content of oxygen in the raw material powder and the volume-based cumulative 50% particle size (D50) measured with a laser diffraction particle size distribution analyzer is preferably 8 (mass %·μm) or less, and more preferably from 0.40 to 7.50 (mass %·μm). A volume-based cumulative 50% particle size (D50) of the raw material powder measured with a laser diffraction particle size distribution analyzer is preferably from 0.1 to 15 μm, and more preferably, from 0.5 to 8 μm. The specific surface area measured by the BET one-point method (BET specific surface area) of the raw material powder is preferably from 0.15 to 3.00 m²/g, more preferably from 0.20 to 2.50 m²/g. A tap density of the raw material powder is preferably from 2.0 to 7.5 g/cm³, more preferably from 2.8 to 6.5 g/cm³. In the case of XRD measurement of the embodiment of the raw material powder, the peak position of the peak at the plane index (1, 1, 0) is usually 2θ=52.40 to 52.55°; the d value is usually from 2.015 to 2.030 Å; the full width at half maximum (FWHM) is usually from 0.100 to 0.180° (the corresponding crystallite size is from 644 to 1,034 Å), and preferably from 0.110 to 0.160° (the corresponding crystallite size is from 658 to 937 Å); and the integral width is usually from 0.160 to 0.240°.

The raw material powder described above can be produced by a known method, for example, a gas atomization method, a water atomization method, a vapor phase method using plasma or the like, or can be purchased as a commercially available product. They may be classified and their particle size distribution may be adjusted.

### (Heat Treatment Step)

In a heat treatment step in the embodiment of the method for performing the heat treatment of the present invention, the raw material powder described above is heat treated at 450 to 1,100° C. in an atmosphere at oxygen concentration of 1 to 2,500 ppm. Performing the heat treatment at such a high temperature is expected to produce an effect of eliminating the residual stress and distortion in the powder as described in [Background of the Invention]. Moreover, in the present invention, performing heat treatment at a high temperature in the presence of oxygen in an amount as small as 1 to 2,500 ppm results in Si localized on the particle surface of the powder, whereby a soft magnetic powder having excellent electrical insulation can be obtained (the soft magnetic powder after the heat treatment step is hereinafter referred to as “powder after heat treatment”). The mechanism is not clear but the following mechanism is presumed. The heat treatment causes atomic diffusion, and the presence of a small amount of oxygen facilitates the diffusion of Si toward the particle surface side. As a result, Si becomes localized on the particle surface in the powder after heat treatment (specifically, the ratio (Si/Fe) of the atomic concentrations of Si and Fe at a depth of 1 nm from the particle surface of the powder after heat treatment is from 4.5 to 30, which is preferably 10 to 40 times the value before heat treatment).

In addition, the presence of oxygen causes oxidation of the powder as well. The oxidation of the powder leads to a decrease in magnetic properties such as saturation magnetization. In the present invention, however, the amount of oxygen in the atmosphere during the heat treatment is so small that oxidation of the powder is minimized and a decrease in the saturation magnetization does not occur substantially. As a result, it is possible to ensure the saturation magnetization to a certain degree, similar to that in the conventional technique.

In the heat treatment step of the embodiment of the method for performing the heat treatment of the present invention, the temperature of the heat treatment is preferably from 500 to 1,000° C., more preferably from 550 to 850° C., from the viewpoint of sufficiently enhancing the electrical insulation of the powder after heat treatment.

In addition, the heat treatment in the heat treatment step is preferably performed for 10 to 1,800 minutes, more preferably 60 to 1,200 minutes, from the viewpoint of enhancing the electrical insulation of the powder after heat treatment and preventing a decrease in productivity and in saturation magnetization of the powder after heat treatment due to oxidation.

The oxygen concentration in the atmosphere in the heat treatment step is preferably from 5 to 1,500 ppm, more preferably from 10 to 1,200 ppm, still more preferably from 60 to 950 ppm, from the viewpoint of appropriately enhancing the electrical insulation of the soft magnetic powder and preventing oxidation to prevent a decrease in saturation magnetization of the powder.

The atmosphere in the heat treatment step is not particularly limited as long as the oxygen concentration is in the above range and does not substantially exhibit reactivity with the raw material powder. It is preferred that the atmosphere substantially consists of oxygen and an inert element, from the viewpoint of suitably achieving the effects of the present invention. Examples of the inert element include helium, neon, argon, nitrogen and the like. Among them, nitrogen is preferable from the viewpoint of cost.

### <Soft Magnetic Material>

The embodiment of the soft magnetic powder of the present invention described above is excellent in electrical insulation as described above, and the saturation magnetization is maintained at the level equal to that in the conventional technology.

Owing to such properties, the embodiment of the soft magnetic powder of the present invention can be suitably applied to a soft magnetic material. The soft magnetic powder may be used by itself as a soft magnetic material or mixed with a binder to prepare a soft magnetic material. In the latter case, for example, a granular composite powder (soft magnetic material) can be obtained by mixing the soft magnetic powder with a binder (insulation resin and/or inorganic binder) followed by granulation. The content of the soft magnetic powder in the soft magnetic material is preferably from 80 to 99.9 mass % from the viewpoint of achieving good magnetic properties. From a similar viewpoint, the content of the binder in the soft magnetic material is preferably from 0.1 to 20 mass %.

Specific examples of the insulation resin include a (meth) acrylic resin, a silicone resin, an epoxy resin, a phenol resin, a urea resin, and a melamine resin. Specific examples of the inorganic binder include a silica binder and an alumina binder. Further, the soft magnetic material (both as a soft magnetic powder alone and a mixture of a powder and a binder) may include other components such as a wax and a lubricant, if necessary.

### <Dust Core>

The soft magnetic material as described above can be molded into a predetermined shape and heated to produce a dust core including an embodiment of a soft magnetic powder of the present invention. More specifically, the soft magnetic material is placed in a mold having a predetermined shape, pressurized and heated to obtain a dust core.

### EXAMPLES

The present invention will be hereinafter described in more detail with reference to Examples, but the present invention is not limited thereby.

### Comparative Example 1

In a tundish furnace, 28.2 kg of electrolytic iron (purity: 99.95 mass % or more), 1.1 kg of silicon metal (purity: 99 mass % or more), and 0.67 kg of ferrochrome (Fe, 33 wt %; Cr, 67 wt %) were heated to melt in a nitrogen atmosphere. The resulting molten metal was rapidly cooled and solidified by spraying high-pressure water (pH 10.3) at a water pressure of 150 MPa and a flow rate of 160 L/min while dropping the molten metal from the bottom of the tundish furnace in a nitrogen atmosphere (oxygen concentration, 0.001 ppm or less). The resulting slurry was separated into solid and liquid, and the solid was washed with water and dried in vacuum at 40° C. for 30 hours.

For the approximately spherical FeSiCr alloy powder 1 obtained in this way, the composition (contents of Fe, Si, Cr, and content of oxygen), particle size distribution, BET specific surface area, tap density, pressed powder resistance R, and magnetic properties were determined. Furthermore, X-ray diffraction (XRD) measurement and ESCA analysis were performed. The results are illustrated in Tables 2 and 3 below.

### [Composition]

The composition of FeSiCr alloy powder 1 was measured as follows.

Fe was analyzed by a titration method in accordance with JIS M8263 (Chromium Ores—Method for Determination of Iron Content) as follows. First, 1.0 g of a sample (FeSiCr alloy powder 1) was heated and decomposed with sulfuric acid and hydrochloric acid added thereto, and heated until white fume of sulfuric acid was evolved. After allowing to cool, water and hydrochloric acid were added and heated to dissolve soluble salts. Subsequently, warm water was added to the obtained sample solution to make the liquid volume about 120 to 130 mL, and the liquid temperature was brought to about 90 to 95°, then, several drops of indigo carmine solution were added, and titanium (III) chloride solution was added until the color of the sample solution turned from yellowish green to blue, and then clear and colorless. Subsequently, a potassium dichromate solution was added until the sample solution retained the blue-color state for 5 seconds. Fe(II) in the sample solution was titrated with potassium dichromate standard solution using an automatic titrator to determine the amount of Fe.

Si was analyzed by gravimetric method as follows. First, the sample (FeSiCr alloy powder 1) was heated and decomposed with hydrochloric acid and perchloric acid added thereto, and heated until white fume of perchloric acid was evolved. Heating on the mixture was continued to dryness. After allowing to cool, water and hydrochloric acid were added and warmed to dissolve soluble salts. Subsequently, the insoluble residue was filtered using a filter paper, and the residue was transferred to a crucible together with the filter paper, and dried and incinerated. After allowing to cool, the total weight of the crucible was weighed. A small amount of sulfuric acid and hydrofluoric acid were added, heated to dryness, and then intensely heated. After allowing to cool, the total weight of the crucible was weighed. Then, the secondly measured weight was subtracted from the firstly measured weight, and considering the weight difference as SiO₂, the Si amount was calculated.

Cr was analyzed using an inductively coupled plasma (ICP) emission spectrometer (SPS3520V, manufactured by Hitachi High-Tech Science Corporation).

The content of oxygen was measured with an oxygen/nitrogen/hydrogen analyzer (EMGA-920, manufactured by HORIBA, Ltd.).

### [Particle Size Distribution]

As for the particle size distribution, a volume-based particle size distribution was determined at a dispersive pressure of 5 bar with a laser diffraction particle size distribution analyzer (HELOS & RODOS (air flow type dispersion module) manufactured by Sympatec GmbH).

### [BET Specific Surface Area]

BET specific surface area was measured by a BET one-point method using a BET specific surface area analyzer (Macsorb, manufactured by MOUNTECH Co., Ltd.) while flowing a mixed gas of nitrogen and helium (N₂: 30 vol %, He: 70 vol %) after degassed by flowing nitrogen gas at 105° C. for 20 minutes in the measuring device.

### [Tap Density]

As for the tap density (TAP), in the same manner as described in Japanese Unexamined Patent Publication No. 2007-263860, a bottomed cylindrical die having an inner diameter of 6 mm and a height of 11.9 mm was packed up to 80% of its volume with FeSiCr alloy powder 1 to form an alloy powder layer, a pressure of 0.160 N/m² was uniformly applied to a top surface of the alloy powder layer, and the alloy powder layer was compressed at that pressure until the alloy powder was no more densely packed. After that, a height of the alloy powder layer was measured, and a density of the alloy powder was determined from the measured height of the alloy powder layer and a weight of the packed alloy powder. The obtained density was defined as a tap density of the FeSiCr alloy powder 1.

### [Pressed Powder Resistance R]

A pressed powder resistance R was measured as follows. After packing 6.0 g of the FeSiCr alloy powder 1 into the measurement container of a powder resistance measurement system (MCP-PD51 type manufactured by Mitsubishi Chemical Analytech Co., Ltd.), pressurization was started, and the volume resistivity of a circular-shaped pressed powder with a cross-section of ϕ 20 mm is measured at the time when an applied load reached 20 kN.

### [Measurement of Magnetic Properties (Permeability, Coercive Force, and Saturation Magnetization)]

An FeSiCr alloy powder 1 and a bisphenol F type epoxy resin (manufactured by TESK CO., LTD.; one-component epoxy resin B-1106) were weighed at a mass ratio of 97:3, and kneaded using a vacuum mixing & degassing mixer (manufactured by EME CORPORATION; V-mini300) to obtain a paste of a test powder dispersed in the epoxy resin. The paste was dried on a hot plate at 30° C. for 2 hours to form a composite of the alloy powder and the resin, and then pulverized into a powder to obtain a composite powder. In a donut-shaped container, 0.2 g of this composite powder was placed and 9,800 N (1 Ton) load was applied by a hand press machine to obtain a toroidal-shaped molding having an outer diameter of 7 mm and an inner diameter of 3 mm. As for the molding, a real part μ′ of a complex relative permeability was measured at 10 MHz using a RF impedance/material analyzer (manufactured by Agilent Technologies, Inc.; E4991A) and a test fixture (manufactured by Agilent Technologies, Inc.; 16454A).

In addition, the magnetic properties of the FeSiCr alloy powder 1 were measured using a high-sensitivity vibration sample magnetometer (manufactured by Toei Industry Co., Ltd.; VSM-P7-15) at an applied magnetic field (10 kOe), M measurement range (50 emu), a step bit of 100 bit, a time constant of 0.03 sec, and a wait time of 0.1 sec. Using a B-H curve, the saturation magnetization as and the coercive force Hc were determined. The processing constant was determined according to the manufacturer's instruction. Specifically, it was as follows.
Intersection detection: Least squares method; M average score, 0; H average score, 0 Ms Width, 8; Mr Width, 8; Hc Width, 8; SFD Width, 8; S. Star Width, 8
   Sampling time (second): 90
   Two-point correction P1 (Oe): 1,000
   Two-point correction P2 (Oe): 4,500

### [X-Ray Diffraction (XRD) Measurement]

The powder XRD pattern was measured using an X-ray diffractometer (Model: RINT-UltimaIII, manufactured by Rigaku Corporation). The X-ray was generated at an acceleration voltage of 40 kV and a current of 30 mA, using cobalt as an X-ray source. An aperture angle of a divergence slit was ⅓°, an aperture angle of a scattering slit was ⅔°, and a light receiving slit width was 0.3 mm. For accurate measurement of the full width at half maximum, the measurement was performed in the range of 20=51.5 to 53.5° by step scan with the measurement interval of 0.02°, counting time of 5 seconds, and the cumulative number of 3.

With the obtained diffraction charts, the peaks at the plane index (1, 1, 0) were analyzed using the powder X-ray analysis software PDXL2, to determine the peak positions, d values, full width at half maximum (FWHM), integral widths, and crystallite size.

### [ESCA Analysis]

The surface composition ratio of the obtained FeSiCr alloy powder 1 was measured by ESCA. The measurement was performed under the following conditions.

Measuring apparatus: PHI 5800, ESCA SYSTEM manufactured by ULVAC-PHI INC.

Measured photoelectron spectra: Fe2p, Si2p

Analyzed diameter: ϕ 0.8 mm

Emission angle of the measured photoelectrons with respect to the sample surface: 45°.

X-ray source: Monochromatic Al radiation source

X-ray source output: 150 W

Background processing: Shirley process

The Ar sputter etching rate was set to be 1 nm/min in terms of SiO₂, and measurement was performed at 81 points for the sputtering time from 0 to 300 min, beginning from the outermost surface. The ratio (Si/Fe) of the atomic concentrations of Si and Fe was determined using the atomic concentration value of Si and the atomic concentration value of Fe at a sputtering time of 1 min and at a sputtering time of 300 min, where the sputtering time of 1 min and the sputtering time of 300 min were assumed to correspond to a depth of 1 nm and a depth of 300 nm, respectively, from the particle surface.

### Comparative Example 2

Approximately spherical FeSiCr alloy powder 2 was obtained in the same manner as in Comparative Example 1, except that 26.9 kg of an electrolytic iron, 1.1 kg of silicon metal, and 2.0 kg of ferrochrome were used as raw materials for preparing a molten metal. For the alloy powder 2, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Example 1

The FeSiCr alloy powder 1 obtained in Comparative Example 1 was heated to 800° C. in a nitrogen atmosphere containing 100 ppm of oxygen at a heating rate of 10° C./min using a furnace, and heat treatment was performed at 800° C. for 960 minutes to obtain FeSiCr alloy powder 3. For the alloy powder 3, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below. The results of ESCA analysis (ratio of atomic concentrations of Si and Fe up to a depth of 300 nm) are illustrated in FIG. 1, together with the results of Comparative Example 1.

### Example 2

The FeSiCr alloy powder 1 obtained in Comparative Example 1 was heated to 500° C. in a nitrogen atmosphere containing 100 ppm of oxygen at a heating rate of 10° C./min using a furnace similar to that in Example 1, and heat treatment was performed at 500° C. for 960 minutes to obtain FeSiCr alloy powder 4. For the alloy powder 4, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Example 3

The FeSiCr alloy powder 1 obtained in Comparative Example 1 was heated to 800° C. in a nitrogen atmosphere containing 100 ppm of oxygen at a heating rate of 10° C./min using a furnace similar to that in Example 1, and heat treatment was performed at 800° C. for 20 minutes to obtain FeSiCr alloy powder 5. For the alloy powder 5, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Example 4

The FeSiCr alloy powder 1 obtained in Comparative Example 1 was heated to 700° C. in a nitrogen atmosphere containing 100 ppm of oxygen at a heating rate of 10° C./min using a furnace similar to that in Example 1, and heat treatment was performed at 700° C. for 60 minutes to obtain FeSiCr alloy powder 6. For the alloy powder 6, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Example 5

The FeSiCr alloy powder 2 obtained in Comparative Example 2 was heated to 700° C. in a nitrogen atmosphere containing 100 ppm of oxygen at a heating rate of 10° C./min using a furnace similar to that in Example 1, and heat treatment was performed at 700° C. for 60 minutes to obtain FeSiCr alloy powder 7. For the alloy powder 7, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Comparative Example 3

The FeSiCr alloy powder 2 obtained in Comparative Example 2 was subjected to heat treatment in an atmosphere at 150° C. for 60 minutes using a shelf-type dryer to obtain FeSiCr alloy powder 8. For the alloy powder 8, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Comparative Example 4

The FeSiCr alloy powder 2 obtained in Comparative Example 2 was subjected to heat treatment in an atmosphere at 200° C. for 60 minutes using a shelf-type dryer to obtain FeSiCr alloy powder 9. For the alloy powder 9, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Comparative Example 5

The FeSiCr alloy powder 1 obtained in Comparative Example 1 was heated to 400° C. in a nitrogen atmosphere containing 100 ppm of oxygen at a heating rate of 10° C./min using a furnace similar to that in Example 1, and heat treatment was performed at 400° C. for 960 minutes to obtain FeSiCr alloy powder 10. For the alloy powder 10, the composition, content of oxygen, particle size distribution, pressed powder resistance, and magnetic properties (including density of dust core) were determined in the same manner as in Comparative Example 1. Furthermore, X-ray diffraction measurement was performed. The results are illustrated in Tables 2 and 3 below.

### Comparative Example 6

The FeSiCr alloy powder 1 obtained in Comparative Example 1 was heated to 800° C. in a CO/CO₂/N₂ atmosphere (oxygen concentration, 0.1 ppm) at a heating rate of 10° C./min using a furnace similar to that in Example 1, and heat treatment was performed at 800° C. for 960 minutes to obtain FeSiCr alloy powder 11. For the alloy powder 11, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Comparative Example 7

Approximately spherical FeSiCr alloy powder 12 was obtained in the same manner as in Comparative Example 1, except that the classification condition was changed to change particle size. For the alloy powder 12, the composition (amounts of Fe, Si, Cr, and content of oxygen), particle size distribution, BET specific surface area, tap density, pressed powder resistance, and magnetic properties were determined in the same manner as in Comparative Example 1. The results are illustrated in Tables 2 and 3 below.

### Example 6

The FeSiCr alloy powder 12 obtained in Comparative Example 7 was heated to 700° C. in a nitrogen atmosphere containing 800 ppm of oxygen at a heating rate of 10° C./min using a furnace similar to that in Example 1, and heat treatment was performed at 700° C. for 240 minutes to obtain FeSiCr alloy powder 13. For the alloy powder 13, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Comparative Example 8

Approximately spherical FeSiCr alloy powder 14 was obtained in the same manner as in Comparative Example 1, except that the classification condition was changed to change particle size. For the alloy powder 14, the composition (amounts of Fe, Si, Cr, and content of oxygen), particle size distribution, BET specific surface area, tap density, pressed powder resistance, and magnetic properties were determined in the same manner as in Comparative Example 1. The results are illustrated in Tables 2 and 3 below.

### Example 7

The FeSiCr alloy powder 14 obtained in Comparative Example 8 was heated to 700° C. in a nitrogen atmosphere containing 2,000 ppm of oxygen at a heating rate of 10° C./min using a furnace similar to that in Example 1, and heat treatment was performed at 700° C. for 240 minutes to obtain FeSiCr alloy powder 15. For the alloy powder 15, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

### Comparative Example 9

Approximately spherical FeSiCr alloy powder 16 was obtained in the same manner as in Comparative Example 1, except that the classification condition was changed to change particle size. For the alloy powder 16, the composition (amounts of Fe, Si, Cr, and content of oxygen), particle size distribution, BET specific surface area, tap density, pressed powder resistance, and magnetic properties were determined in the same manner as in Comparative Example 1. The results are illustrated in Tables 2 and 3 below.

### Example 8

The FeSiCr alloy powder 16 obtained in Comparative Example 9 was heated to 700° C. in a nitrogen atmosphere containing 2,000 ppm of oxygen at a heating rate of 10° C./min using a furnace similar to that in Example 1, and heat treatment was performed at 700° C. for 240 minutes to obtain FeSiCr alloy powder 17. For the alloy powder 17, the composition (amounts of Fe, Si, Cr, and content of oxygen), particle size distribution, BET specific surface area, tap density, pressed powder resistance, and magnetic properties were determined in the same manner as in Comparative Example 1. Furthermore, X-ray diffraction (XRD) measurement and ESCA analysis were performed. The results are illustrated in Tables 2 and 3 below.

The heat treatment conditions of the above Examples 1 to 8 and Comparative Examples 1 to 9 are illustrated in Table 1 below, the powder properties of the alloy powders 1 to 17 obtained using the heat treatment conditions are illustrated in Table 2 below, and the insulation properties and the magnetic properties of the alloy powder 1 to 17 are illustrated in Table 3 below (the ratio (Si/Fe) of the atomic concentrations of Si and Fe at a depth of 1 nm from the particle surface is re-displayed for reference in Table 3).

TABLE 1

Heat treatment conditions

| | | |
|---|---|---|
| Temperature | Oxygen | Time |
| ° C. | concentration | min |

| | |
|---|---|
| Com. Ex. 1 | Not treated |

| | | | | |
|---|---|---|---|---|
| Example 1 | 800 | 100 | ppm | 960 |
| Example 2 | 500 | 100 | ppm | 960 |
| Example 3 | 800 | 100 | ppm | 20 |
| Example 4 | 700 | 100 | ppm | 60 |
| Com. Ex. 5 | 400 | 100 | ppm | 960 |
| Com. Ex. 6 | 800 | 0.1 | ppm | 960 |

| | |
|---|---|
| Com. Ex. 2 | Not treated |

| | | | | |
|---|---|---|---|---|
| Example 5 | 700 | 100 | ppm | 60 |

| | | | |
|---|---|---|---|
| Com. Ex. 3 | 150 | A | 60 |
| Com. Ex. 4 | 200 | A | 60 |

| | |
|---|---|
| Com. Ex. 7 | Not treated |

| | | | | |
|---|---|---|---|---|
| Example 6 | 700 | 800 | ppm | 240 |

| | |
|---|---|
| Com. Ex. 8 | Not treated |

| | | | | |
|---|---|---|---|---|
| Example 7 | 700 | 2000 | ppm | 240 |

| | |
|---|---|
| Com. Ex. 9 | Not treated |

| | | | | |
|---|---|---|---|---|
| Example 8 | 700 | 2000 | ppm | 240 |

Com. Ex. = Comparative Example
A = Atmospheric air

TABLE 2

| | | | | | | | | | | | | XRD (1, 1, 0) | |
|---|---|---|---|---|---|---|---|---|---|---|---|---|---|
| | Composition | | | | Particle size distribution | | | | | | Tap | Peak | |
| | Fe | Si | Cr | O | D10 | D50 | D90 | D99 | O × D50 | BET | density | position | d value |
| | wt % | wt % | wt % | wt % | μm | μm | μm | μm | wt % · μm | m²/g | g/cm³ | 2 θ(deg) | Å |
| Com.Ex. 1 | 94 | 3.5 | 1.5 | 0.54 | 1.0 | 2.0 | 3.5 | 5.9 | 1.07 | 0.73 | 3.6 | 52.45 | 2.026 |
| Ex. 1 | 94 | 3.5 | 1.5 | 0.64 | 1.0 | 2.0 | 3.5 | 5.9 | 1.26 | 0.64 | 3.4 | 52.46 | 2.025 |
| Ex. 2 | 94 | 3.5 | 1.5 | 0.50 | 1.0 | 2.0 | 3.5 | 5.9 | 0.99 | 0.73 | 3.5 | 52.47 | 2.025 |
| Ex. 3 | 94 | 3.4 | 1.5 | 0.53 | 1.0 | 2.0 | 3.5 | 5.9 | 1.04 | 0.64 | 3.6 | 52.47 | 2.025 |
| Ex. 4 | 94 | 3.5 | 1.5 | 0.69 | 1.0 | 2.0 | 3.5 | 5.9 | 1.35 | 0.88 | 3.3 | 52.50 | 2.024 |
| Com.Ex. 5 | 94 | 3.5 | 1.5 | 0.59 | 1.0 | 2.0 | 3.5 | 5.9 | 1.17 | 0.73 | 3.6 | 52.47 | 2.025 |
| Com.Ex. 6 | 94 | 3.5 | 1.5 | 0.54 | 0.9 | 1.9 | 3.4 | 7.1 | 1.03 | 0.78 | 3.3 | 52.46 | 2.025 |
| Com.Ex. 2 | 91 | 3.7 | 4.6 | 0.56 | 0.9 | 1.9 | 3.4 | 7.9 | 1.06 | 0.81 | 3.4 | 52.45 | 2.026 |
| Ex. 5 | 91 | 3.7 | 4.5 | 0.53 | 1.0 | 1.9 | 3.5 | 7.9 | 1.02 | 0.83 | 3.4 | 52.45 | 2.026 |
| Com.Ex. 3 | 91 | 3.6 | 4.5 | 0.67 | 1.1 | 2.2 | 4.0 | 7.0 | 1.49 | 0.78 | 3.3 | 52.50 | 2.024 |
| Com.Ex. 4 | 91 | 3.7 | 4.4 | 0.82 | 1.1 | 2.2 | 4.0 | 7.0 | 1.81 | 0.76 | 3.2 | 52.44 | 2.026 |
| Com.Ex. 7 | 93 | 3.6 | 1.5 | 0.46 | 1.6 | 3.8 | 7.2 | 11.3 | 1.76 | 0.60 | 3.7 | — | — |
| Ex. 6 | 93 | 3.6 | 1.6 | 0.63 | 1.6 | 3.8 | 7.0 | 10.4 | 2.38 | 0.53 | 3.6 | 52.48 | 2.025 |
| Com.Ex. 8 | 93 | 3.6 | 1.5 | 0.41 | 2.8 | 6.0 | 11.5 | 18.0 | 2.45 | 0.32 | 3.9 | — | — |
| Ex. 7 | 93 | 3.6 | 1.5 | 0.73 | 2.7 | 5.9 | 11.7 | 18.4 | 4.34 | 0.37 | 3.8 | 52.46 | 2.025 |
| Com.Ex. 9 | 93 | 3.6 | 1.5 | 0.65 | 2.8 | 7.0 | 21.7 | 28.1 | 4.54 | 0.28 | 4.2 | — | — |
| Ex. 8 | 93 | 3.6 | 1.5 | 0.93 | 3.0 | 7.9 | 26.0 | 61.9 | 7.30 | 0.29 | 4.0 | 52.48 | 2.025 |

| | | | | ESCA analysis | | | | | |
|---|---|---|---|---|---|---|---|---|---|
| | | | | | | | | Si/Fe | |
| | XRD (1, 1, 0) | | | Si | | Fe | | Atomic | |
| | | Integral | Crystallite | Atomic | | Atomic | | Concentration | |
| | FWHM | width | size | Concentration | | Concentration | | Ratio | |
| | deg | deg | Å | D1 | D300 | D1 | D300 | D1 | D300 |
| Com.Ex. 1 | 0.126 | 0.189 | 816 | 14.4 | 1.8 | 23.0 | 91.3 | 0.6 | 0.02 |
| Ex. 1 | 0.083 | 0.113 | 1247 | 28.9 | 2.0 | 1.7 | 89.2 | 17.4 | 0.02 |
| Ex. 2 | 0.101 | 0.142 | 1022 | 22.3 | 2.2 | 2.8 | 90.2 | 8.0 | 0.02 |
| Ex. 3 | 0.084 | 0.114 | 1218 | 25.5 | 2.1 | 1.9 | 89.5 | 13.4 | 0.02 |
| Ex. 4 | 0.099 | 0.140 | 1039 | 21.2 | 2.3 | 2.2 | 88.8 | 9.6 | 0.03 |
| Com.Ex. 5 | 0.126 | 0.186 | 819 | 14.9 | 3.1 | 23.1 | 90.0 | 0.6 | 0.03 |
| Com.Ex. 6 | 0.085 | 0.118 | 1207 | 20.1 | 2.0 | 5.2 | 95.7 | 3.9 | 0.02 |
| Com.Ex. 2 | 0.118 | 0.180 | 875 | 12.6 | 2.2 | 29.3 | 86.6 | 0.4 | 0.03 |
| Ex. 5 | 0.099 | 0.140 | 1042 | 18.2 | 2.5 | 2.0 | 90.5 | 9.1 | 0.03 |
| Com.Ex. 3 | 0.154 | 0.226 | 667 | 7.6 | 1.8 | 37.4 | 89.5 | 0.2 | 0.02 |
| Com.Ex. 4 | 0.126 | 0.189 | 814 | 5.9 | 2.1 | 38.8 | 87.8 | 0.2 | 0.02 |
| Com.Ex. 7 | — | — | — | — | — | — | — | — | — |
| Ex. 6 | 0.104 | 0.138 | 993 | 20.5 | 1.9 | 4.0 | 89.7 | 5.1 | 0.02 |
| Com.Ex. 8 | — | — | — | — | — | — | — | — | — |
| Ex. 7 | 0.098 | 0.131 | 1055 | 27.0 | 2.0 | 3.6 | 90.5 | 7.5 | 0.02 |
| Com.Ex. 9 | — | — | — | — | — | — | — | — | — |
| Ex. 8 | 0.091 | 0.122 | 1127 | 25.6 | 2.0 | 3.0 | 90.1 | 8.5 | 0.02 |

Ex. = Example
Com.Ex. = Comparative Example
D1 = Depth 1 nm
D300 = Depth 300 nm

TABLE 3

| | Heat treatment conditions | | | | E | R | Magnetic properties | | | |
|---|---|---|---|---|---|---|---|---|---|---|
| | Temperature | Oxygen | | Time | Si/Fe | 20 kN | | os | Hc | log R × o s |
| | ° C. | concentration | | min | Depth 1 nm | Ω · cm | μ′ | emu/g | Oe | emu/g |
| Com.Ex. 1 | Not treated | | | | 0.6 | 9.3E+01 | 17.3 | 193 | 22 | 381 |
| Ex. 1 | 800 | 100 | ppm | 960 | 17.4 | 1.1E+05 | 15.1 | 194 | 19 | 978 |
| Ex. 2 | 500 | 100 | ppm | 960 | 8.0 | 5.6E+03 | 16.0 | 194 | 21 | 726 |
| Ex. 3 | 800 | 100 | ppm | 20 | 13.4 | 4.1E+04 | 16.0 | 194 | 19 | 894 |
| Ex. 4 | 700 | 100 | ppm | 60 | 9.6 | 9.3E+03 | 16.0 | 193 | 23 | 767 |
| Com.Ex. 5 | 400 | 100 | ppm | 960 | 0.6 | 7.3E+00 | 16.0 | 193 | 21 | 167 |
| Com.Ex. 6 | 800 | 0.1 | ppm | 960 | 3.9 | 4.2E+01 | 16.0 | 194 | 22 | 316 |
| Com.Ex. 2 | Not treated | | | | 0,4 | 3.3E+02 | 16.5 | 184 | 27 | 463 |
| Ex. 5 | 700 | 100 | ppm | 60 | 9.1 | 4.9E+03 | 14.9 | 185 | 23 | 682 |
| Com.Ex. 3 | 150 | A | | 60 | 0.2 | 1.6E+02 | 14.9 | 182 | 22 | 399 |
| Com.Ex. 4 | 200 | A | | 60 | 0.2 | 1.1E+03 | 14.1 | 181 | 23 | 553 |
| Com.Ex. 7 | Not treated | | | | — | 2.0E+02 | 19.1 | 194 | 19 | 444 |
| Ex. 6 | 700 | 800 | ppm | 240 | 5.1 | 1.5E+04 | 18.1 | 194 | 18 | 811 |
| Com.Ex. 8 | Not treated | | | | — | 7.2E+00 | 21.2 | 193 | 17 | 166 |
| Ex. 7 | 700 | 2000 | ppm | 240 | 7.5 | 3.3E+04 | 19.0 | 193 | 17 | 872 |
| Com.Ex. 9 | Not treated | | | | — | 8.2E+00 | 22.2 | 192 | 16 | 176 |
| Ex. 8 | 700 | 2000 | ppm | 240 | 8.5 | 2.2E+04 | 20.7 | 191 | 15 | 830 |

Ex. = Example
Com.Ex. = Comparative Example
A = Atmospheric air
E = ESCA analysis
R = Pressed powder resistance R

The ratio (Si/Fe) of the atomic concentrations of Si and Fe at a depth of 1 nm from the particle surface was 1 or less for the raw material powder before heat treatment (Comparative Examples 1 and 2), and the ratio (Si/Fe) at a depth of 300 nm was about 0.03. Thus, in the FeSiCr alloy powder produced by the water atomization method, a certain degree of Si localization (segregation) to the particle surface was observed before heat treatment, but the pressed powder resistance R was insufficient.

When this raw material powder (Comparative Example 2) was heat-treated at 200° C. or less in an atmosphere (Comparative Examples 3 and 4), almost no change was observed in the ratio (Si/Fe) of atomic concentration at a depth of 1 nm, and content of oxygen and O×D50 (mass %·μm) increased slightly. Compared to the raw material powder, the pressed powder resistance R increased only slightly, the electrical insulation was insufficient, and the saturation magnetization as deteriorated slightly.

When the raw material powder of Comparative Example 1 was heat-treated at relatively low temperature in an atmosphere containing a trace amount of oxygen as specified in the present invention (Comparative Example 5), almost no change was observed in the ratio (Si/Fe) of atomic concentration at a depth of 1 nm. When the raw material powder of Comparative Example 1 was heat-treated at high temperature in an atmosphere with substantially no oxygen existing therein (Comparative Example 6), the ratio (Si/Fe) of the atomic concentration at a depth of 1 nm increased to a certain extent. In both of these, however, there was no change in the saturation magnetization as, and the electrical insulation worsened slightly, compared to the raw material powder.

On the other hand, when the method for performing the heat treatment of the present invention was performed to the raw material powder of Comparative Examples 1 and 2 (Examples 1 to 5), the ratio (Si/Fe) of the atomic concentration at a depth of 1 nm increased greatly to 8.0 or more, and the electrical insulation also increased by two digits or more. On the other hand, there was no change in saturation magnetization as, which was at the level equal to that of the raw material powder.

To specifically describe the distribution of Si in the soft magnetic powder of Example 1 and Comparative Example 1, the ratio (Si/Fe) of the atomic concentration is 1 or less and does not change significantly at any depth, as illustrated by the dashed line in FIG. 1(a), and Si exists almost uniformly in the soft magnetic powder of Comparative Example 1. In contrast, in the soft magnetic powder of Example 1, as illustrated by the solid line, the ratio (Si/Fe) is uniform and 0.5 or less, without changing significantly inside the particle (in the deep region at a depth of 30 nm or more from the particle surface), but it increases from a depth of about 10 nm toward the surface side and reaches 17.4 at a depth of 1 nm, so that Si is localized on the surface side. Thus, using the soft magnetic powder in which Si is localized on the surface side, higher electrical insulation can be obtained while maintaining the saturation magnetization at the equal level, compared to the soft magnetic powder in which Si exists uniformly.

A similar effect was observed when the method for performing the heat treatment of the present invention was performed to the raw material powder (Comparative Examples 7 to 9) having particle sizes different from those of Comparative Examples 1 and 2 (Examples 6 to 8). In these examples, the magnetic permeability is higher than that of Examples 1 to 5. The reason is supposed that the alloy powders of these examples have particle size distributions different from that of the FeSiCr alloy powder of Examples 1 to 5, so that the packing properties of the particles are enhanced in the formation of the toroidal-shaped molding during measurement of the magnetic properties.

1. A soft magnetic powder,
comprising an Fe alloy; and
containing 0.1 to 15 mass % of Si,
wherein a ratio (Si/Fe) of an atomic concentration of Si and an atomic concentration of Fe is from 4.5 to 30 at a depth of 1 nm from a particle surface of the soft magnetic powder.

2. The soft magnetic powder according to claim 1, wherein a volume-based cumulative 50% particle size (D50) measured with a laser diffraction particle size distribution analyzer is 0.1 to 15 μm.

3. The soft magnetic powder according to claim 1, containing 84 to 99.7 mass % of Fe.

4. The soft magnetic powder according to claim 1, containing 0.2 to 10 mass % of Si.

5. The soft magnetic powder according to claim 1, further containing Cr, wherein a content of the Cr is 0.1 to 8 mass %.

6. The soft magnetic powder according to claim 1, wherein the volume-based cumulative 50% particle size (D50) measured with a laser diffraction particle size distribution analyzer is 0.5 to 8 μm.

7. A method for performing a heat treatment to a soft magnetic powder, comprising performing a heat treatment to a soft magnetic powder comprising an Fe alloy containing 0.1 to 15 mass % of Si at 450 to 1,100° C. in an atmosphere at oxygen concentration of 1 to 2,500 ppm.

8. The method for performing a heat treatment to the soft magnetic powder according to claim 7, wherein the heat treatment is performed for 10 to 1,800 minutes.

9. The method for performing a heat treatment to the soft magnetic powder according to claim 7, wherein the soft magnetic powder subjected to the heat treatment further contains Cr, and a content of the Cr is 0.1 to 8 mass %.

10. A soft magnetic material comprising the soft magnetic powder according to claim 1 and a binder.

11. A dust core comprising the soft magnetic powder according to claim 1.

12. A method for production of a dust core, comprising:
molding the soft magnetic powder according to claim 1 into a predetermined shape; and
heating the obtained molding to obtain a dust core.
